(19) United States
(12) Patent Application Publication
(10) Pub. No.: US 2026/0196528 A1
(43) Pub. Date: Jul. 9, 2026

(54) FUEL CELL STACK SUB-ASSEMBLY

(71) Applicant: GM GLOBAL TECHNOLOGY OPERATIONS LLC, Detroit, MI (US)

(72) Inventors: Joseph Hahn, White Lake Charter Township, MI (US); Yan Zhang, Oakland Township, MI (US); Brian Podczervinski, West Bloomfield, MI (US); Anthony George Chinnici, Utica, MI (US)

(73) Assignee: GM GLOBAL TECHNOLOGY OPERATIONS LLC, Detroit, MI (US)

(21) Appl. No.: 19/014,763

(22) Filed: Jan. 9, 2025

(51) Int. Cl. H01M 8/0276; B60L 50/72; H01M 8/0202; H01M 8/0228; H01M 8/04119; H01M 8/10

(52) U.S. Cl. CPC H01M 8/0276; H01M 8/0228; H01M 8/0269; H01M 8/04156; B60L 50/72; H01M 2008/1095; H01M 2250/20

(57) ABSTRACT

Disclosed is a fuel cell stack sub-assembly. The fuel stack sub-assembly may include a compression band that is adjustable. The fuel stack sub-assembly may include polymeric or composite end units with integrated balance of plant.

### INTRODUCTION

The technical field generally relates to fuel cells and components thereof.

Fuel cell systems contain a series of bipolar plates which are contained within the system at high compressive loads. This high compressive load is contained within an enclosure typically constructed of aluminum or other metallic materials. A plurality of balance of plant systems must then interface with this enclosure, and ultimately the plates within, in order to maintain proper flows of a number of materials including coolant, hydrogen, and air.

Accordingly, it is desirable to provide a fuel cell system and a method of assembly which reduces weight and complexity. Furthermore, other desirable features and characteristics of the patentable variations will become apparent from the subsequent detailed description and the appended claims, taken in conjunction with the accompanying drawings and the foregoing introduction.

### SUMMARY

A number of variations may include a product including: a fuel cell compression band including a first piece including a first end portion having a first plurality of parallel elongated slots formed therein.

A number of variations may include a product wherein the first piece of the fuel cell compression band includes a second end portion having a second plurality of parallel elongated slots formed therein.

A number of variations may include a product wherein the fuel cell compression band includes a second piece having a first end portion having a plurality of threaded weld studs positioned so that one of the plurality of threaded weld studs extends through one of the first plurality of parallel elongated slots.

A number of variations may include a product wherein the fuel cell compression band includes a second piece having a second end portion including a plurality of threaded weld studs positioned so that one of the plurality of threaded weld studs extends through one of the first plurality of parallel elongated slots.

A number of variations may include a product further including a wet end unit including a first polymeric material, a dry end unit including a second polymeric material, and a fuel cell block between the wet end unit and the dry end unit, and wherein the fuel cell compression band is compressing the wet end unit, the fuel cell block, and the dry end unit.

A number of variations may include a product wherein the first polymeric material and the second polymeric material each include a fiber glass reinforced polymer.

A number of variations may include a product further including at least one of an ejector, water separator, or back flow prevention device integrated into the wet end unit.

A number of variations may include a product further including a collector plate over molded in at least one of the wet end unit or the dry end unit.

A number of variations may include a product further including a plurality of ribs in at least one of the wet end unit or the dry end unit.

A number of variations may include a product further including a plurality of ribs in the wet end unit constructed and arranged to support water separation in the wet end unit.

A number of variations may include a product further including a plurality of ribs in at least one of the wet end unit or the dry end unit, wherein the plurality of ribs is constructed and arranged to transfer mechanical load or accommodate thermal expansion of the fuel cell block.

A number of variations may include a product further including thermal loop integrated in at least one of the wet end unit or the dry end unit.

A number of variations may include a product wherein the fuel cell block includes a plurality of bipolar plates and an over molded bus bar constructed and arranged to electrically connect to the fuel cell block.

A number of variations may include a product further including an over molded bus bar electrically connected to the fuel cell block.

A number of variations may include a product including: a fuel cell sub-assembly including a wet end unit including a first polymeric material, a dry end unit including a second polymeric material, and a fuel cell block between the wet end unit and the dry end unit, and at least one of an ejector, water separator, or back flow prevention device integrated into the wet end unit.

A number of variations may include a product further including: a fuel cell compression band compressing the wet end unit, the fuel cell block, and the dry end unit.

A number of variations may include a product wherein the fuel cell compression band includes a first piece including a first end portion having a first plurality of parallel elongated slots formed therein.

A number of variations may include a product wherein fuel cell compression band includes a second piece having a first end portion having a plurality of threaded weld studs positioned so that one of the plurality of threaded weld studs extends through one of the first plurality of parallel elongated slots.

A number of variations may include a product further including a collector plate over molded in the wet end unit or the dry end unit.

A number of variations may include a vehicle including: a full cell comprising a wet end unit including a first polymeric material, a dry end unit including a second polymeric material, and a fuel cell block between the wet end unit and the dry end unit, a fuel cell compression band being constructed and arranged to have a variable length, the fuel cell compression band including a first piece including a first end portion having a first plurality of parallel elongated slots formed therein, the fuel cell compression band including a second piece having a first end portion having a plurality of threaded weld studs positioned so that one of the plurality of threaded weld studs extends through one of the first plurality of parallel elongated slots, a plurality of threaded nuts, wherein one of the plurality of threaded nuts is threaded on one of the plurality of threaded weld studs extend extending through one of the first plurality of parallel elongated slots so that the fuel cell compression band compresses the wet end unit, the fuel cell block, and the dry end unit.

### BRIEF DESCRIPTION OF THE DRAWINGS

The illustrative variations will hereinafter be described in conjunction with the following drawing figures, wherein like numerals denote like elements, and wherein:

FIG. 1 is a perspective view of a fuel cell assembly including a fuel cell compression band that is adjustable, and a dry end unit and a wet end unit each including a polymeric material according to a number of variations;

FIG. 2 is a top view of the fuel cell assembly shown in FIG. 1;

FIG. 3 is an end view of the fuel cell assembly shown in FIG. 1 looking at the wet end unit;

FIG. 4 is a side view of the fuel cell assembly shown in FIG. 1;

FIG. 5 is a perspective view of a fuel cell compression band that is adjustable according to a number of variations;

FIG. 6 is a top view of the fuel cell compression band shown in FIG. 5;

FIG. 7 is a side view of the fuel cell compression band shown in FIG. 5;

FIG. 8 is an end view of the fuel cell compression band shown in FIG. 5;

FIG. 9 is a side view of a fuel cell assembly showing a fuel cell compression band adjusted to a first length according to a number of variations;

FIG. 10 illustrates a method of adjusting the fuel cell compression band shown in FIG. 9 to have a second length that is shorter than the first length according to a number of variations;

FIG. 11 illustrates a method of adjusting the fuel cell compression band shown in FIG. 9 to have third length that is longer than the first length according to a number of variations;

FIG. 12 illustrates an end view of a fuel cell assembly having an anode subassembly integrated within the non-repeating hardware of a fuel cell stack according to a number of variations;

FIG. 13 illustrates and in view looking at the wet end unit of a fuel cell assembly and including components such as injectors mounted outside of the fuel cell stack enclosure according to a number of variations;

FIG. 14 is a perspective view of a fuel cell assembly looking at an end unit including a polymeric material having a thermal loop formed therein according to a number of variations;

FIG. 15 is an end view of the fuel cell assembly shown in FIG. 14;

FIG. 16 is a perspective view of a wet end unit for a fuel cell assembly, wherein the wet end unit includes a plurality of ribs according to a number of variations;

FIG. 17 is an end view of the wet end unit shown in FIG. 1;

FIG. 18 is a perspective view, with portion shown in fantom lines, looking at an outer face of a dry end unit having a collector plate over molded by a polymeric material of the dry end unit according to a number of variations;

FIG. 19 is a perspective view looking at an outer face of a dry end unit having a collector plate over molded by a polymeric material and a terminal extending out of the polymeric material according to a number of variations;

FIG. 20 is a perspective view looking at an inner face of a wet end unit having a collector plate over molded by a polymeric material of the wet end unit according to a number of variations;

FIG. 21 is a perspective view looking at an inner face of a wet end unit having a collector plate over molded by a polymeric material and showing an integrated balance of plant in fantom lines according to a number of variations;

FIG. 22 is a schematic illustration of a fuel cell stack including a fuel cell compression band that is adjustable to accommodate additional fuel cells and additional components, wherein the fuel cell compression band includes a first piece and a second piece, wherein the second piece has a length greater than the first piece according to a number of variations;

FIG. 23 is a schematic illustration showing an over molded bus bar and the second piece of the fuel cell compression band shown in FIG. 22;

FIG. 24 is a schematic illustration of a fuel cell stack including a fuel cell compression band that is adjustable to accommodate fewer fuel cells and additional components, wherein the fuel cell compression band includes a first piece, a modified second piece, and a modified over molded bus bar according to a number of variations;

FIG. 25 is a schematic illustration showing an over molded bus bar and the second piece of the fuel cell compression band shown in FIG. 23; and

FIG. 26 is a schematic illustration of a vehicle including a fuel cell stack according to a number of variations.

### DETAILED DESCRIPTION

The following detailed description is merely illustrative in nature and is not intended to limit the application and uses. Furthermore, there is no intention to be bound by any expressed or implied theory presented in the preceding introduction, brief description of the drawings, brief summary or the following detailed description.

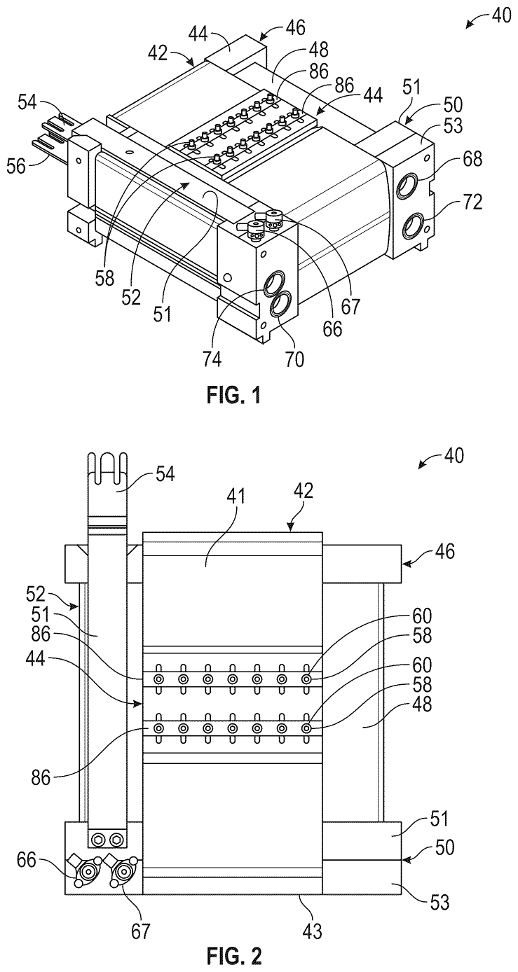

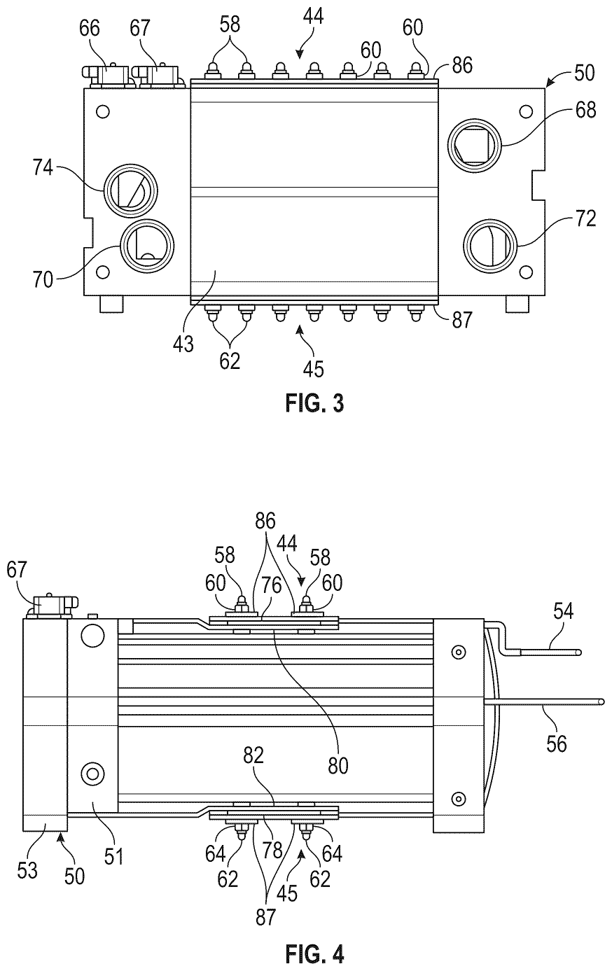

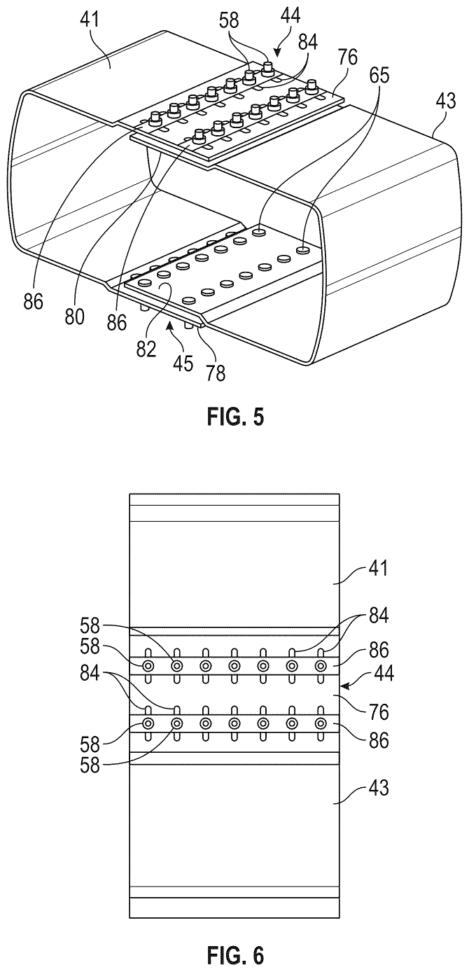

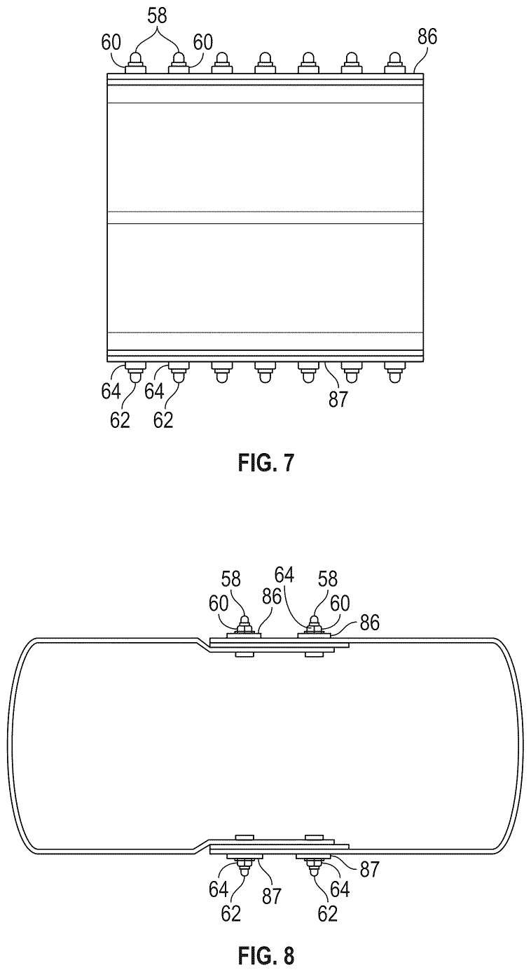

FIGS. 1-8 illustrate a number of variations, which may include a product which may include a fuel cell stack sub-assembly 40. The fuel cell stack sub-assembly 40 may include a fuel cell compression band 42 including a first piece 41 and a second piece 43 connected together by a first locking mechanism 44 and a second locking mechanism 45. The fuel cell stack sub-assembly 40 may include a fuel cell block 48 containing a plurality of bipolar plates and proton exchange membranes in a manner known to those skilled in the art. The fuel cell stack sub-assembly 40 may include a dry end unit 46 on one side of the fuel cell block 48 and a wet end unit 50 on an opposite side of the fuel cell block 48. An over molded bus bar 52 and the first electrical contact 54. A second bus bar 56 for collecting current from the fuel cell block 48. The fuel cell compression band may compress the dry end unit 46, the fuel cell block 48, and the wet end unit 50. The fuel cell stack sub-assembly 40 may include a first plurality of threaded weld studs 58 extending through a first end portion 76 of the first piece 41 and a first end portion 80 of the second piece 43. A washer plate 86 may include through holes through which the first plurality of threaded weld studs 58 may extend. A first plurality of threaded nuts 60 may be provided for threating onto the first plurality of threaded weld studs 58 to fasten together the first piece 41 and the second piece 43 of the fuel cell compression band 42. Similarly, a second end portion 78 of the first piece 41 and a second end portion 82 of the second piece 43 may have a second plurality of threaded weld studs 62 extending therethrough and fastened together by a plurality of threaded nuts 64. A washer plate 87 similar to 86 may be provided under the second plurality of threaded nuts 64. The first end portion 76 and the second end portion 78 of the first piece 41 may include a plurality of parallel elongated slots 84 formed therein through which the first plurality of threaded weld studs 58 may extend to allow the length of the fuel cell compression band 42 to be adjusted to accommodate fuel cell stack length variations, and to accommodate a larger or smaller fuel cells in the fuel cell block 48, or to accommodate the addition of other components contained by the fuel cell compression band 42 (as will be described hereafter). In a similar manner, a plurality of parallel elongated slots (not shown) may be formed in the second end portion 82 of the first piece 41 through which the second plurality of threaded weld studs 62 may extend there through to allow the length of the fuel cell compression band 42 to be adjusted to accommodate fuel cell stack length variations, and to accommodate a larger or smaller fuel cells in the fuel cell block 48, or to accommodate the addition of other components contained by the fuel cell compression band 42 (as will be described hereafter). A head 65 may be included on the threaded weld studs 62, 58.

The fuel cell compression band 42 and first locking mechanism 44 and/or second locking mechanism 45 may provide sufficient compression and sealing without the use of metallic bead seals on the bipolar plates in the fuel cell block 48. A metallic bead seal on a bipolar plate is a raised, bead-like structure formed directly onto the surface of the metallic bipolar plate, acting as an integrated sealing mechanism to prevent fluid leakage between adjacent plates within a fuel cell stack; essentially, it is a raised, stamped edge on the plate that creates a tight seal when compressed against another plate, eliminating the need for separate gaskets in many cases. Suitable fuel cell bipolar plates with metallic bead seals, and proton exchange membranes, are known to those skilled in the art, for example such those disclosed in U.S. Patent Publication No. 2009/0197147A1, by Fly et al., U.S. Ser. No. 12/023,376 , filed Jan. 31, 2008.

The wet end unit 50 may include a first end portion 51 and a second end portion 53 which may include a polymeric material which may be a composite such as fiberglass reinforced polymer. At least one of the first end portion 51 or second end portion 53 may include an air inlet port 68, an air outlet port 70, a cooling inlet port 72, or a coolant outlet port 74. A first pressure sensor 66 and a second pressure sensor 67 may be provide external to the first end portion 51 or second end portion 53 to allow for easy access to service the same.

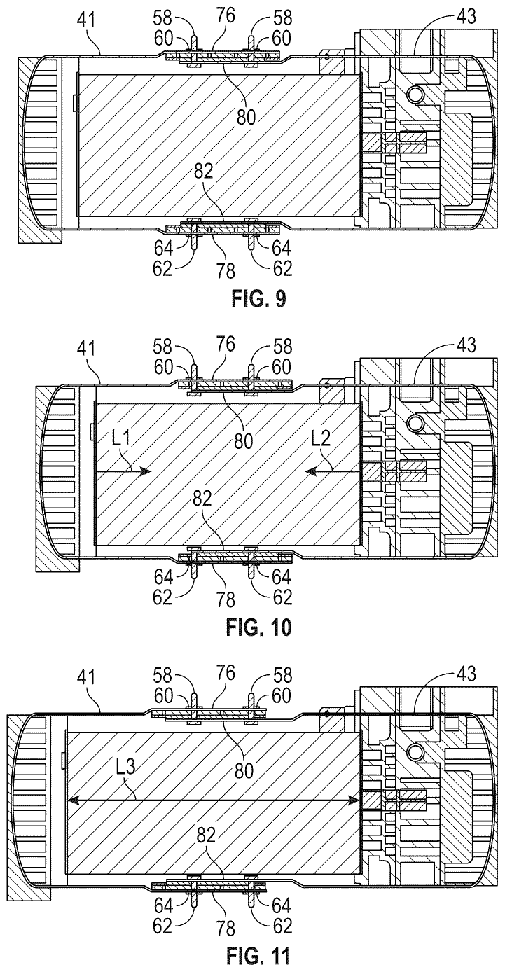

FIG. 9 illustrates the fuel cell compression band 42 adjusted to a first length. FIG. 10 illustrates the fuel cell compression band 42 adjusted to a second length that is shorter than the first length by moving the first piece 41 in the direction of line L1 toward the second piece 43 and/or moving the second piece 43 in the direction of line L2 toward the first piece. FIG. 11 illustrates the fuel cell compression band 42 adjusted to a third length that is longer than the first length by moving the first piece 41 in the direction away from the second piece 43 and/or moving the second piece 43 away from the first piece 41, for example as illustrated by line L3.

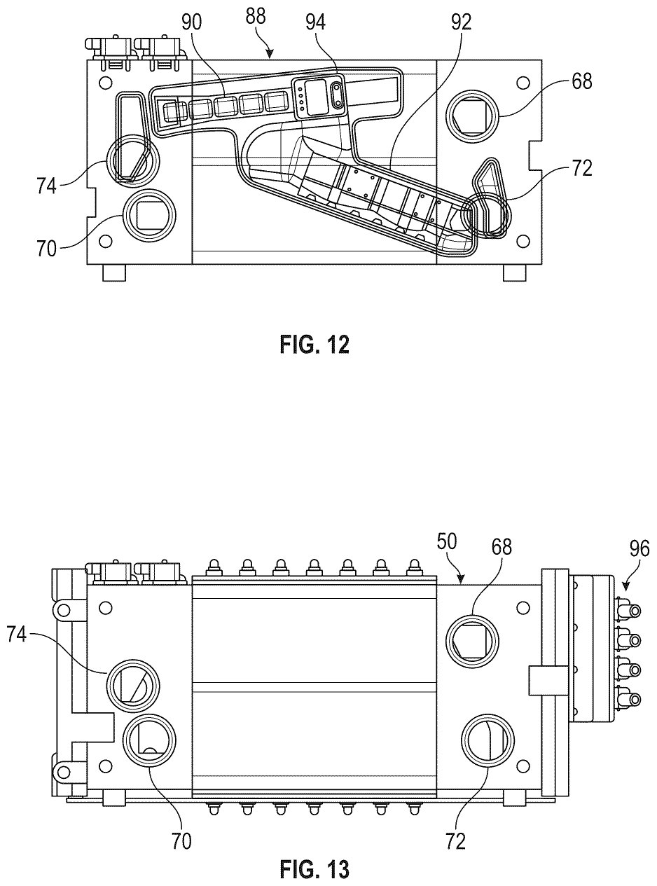

FIG. 12 illustrates an anode subassembly 88 integrated with the non-repeating hardware of the fuel cell stack. The anode subassembly 88 may include an ejector 90, an anode water separator 92, and a backflow prevention device 94 there between. The anode subassembly 88 may be carried in at least one of the first end portion 51 or second end portion 53 of the wet end unit 50.

FIG. 13 illustrates a variation wherein components which require service such as injectors 96 may be located outside the fuel cell stack enclosure while still maintaining improved integration of the overall system.

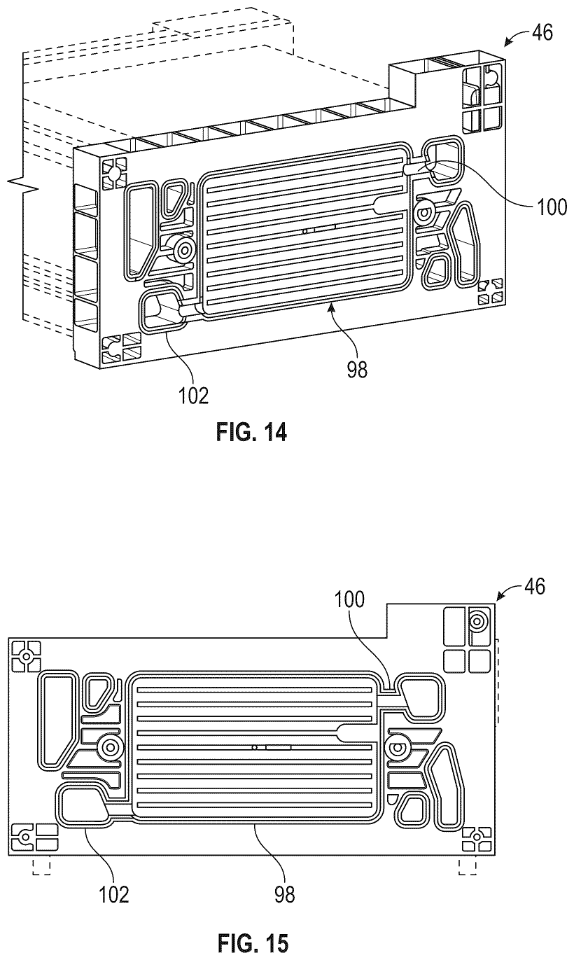

FIGS. 14-15 illustrate a thermal loop 98 which may be formed in the dry end unit 46, the wet end unit 50, or both. The thermal loop 98 may include an inlet 100 and an outlet 102. A slipstream to the high temperature coolant in and out of the stack may be provided to heat end cells of the stack to prevent condensation flooding of the end cells. Providing a thermal loop 98 in the dry end unit 46, the wet end unit 50, or both may eliminate the need for dummy cells to flow coolant for end cell heating. Such dummy cells are expensive due to their unique design and low quantity.

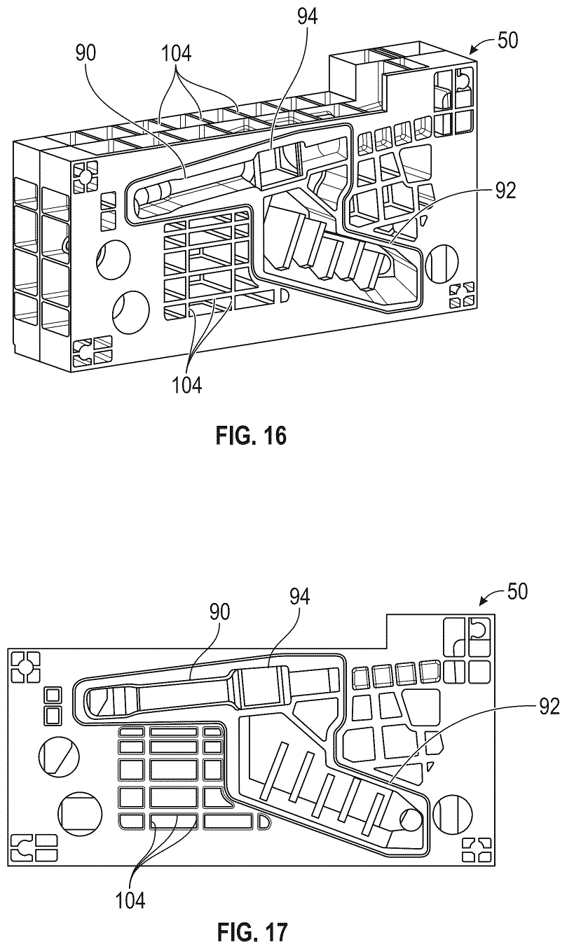

FIGS. 16-17 illustrate support ribs 104 that may be formed in the dry end unit 46, wet end unit 50, or both to support the function of anode water separation, as well as for structural support by transfer mechanical load from one side of a cavity to the other.

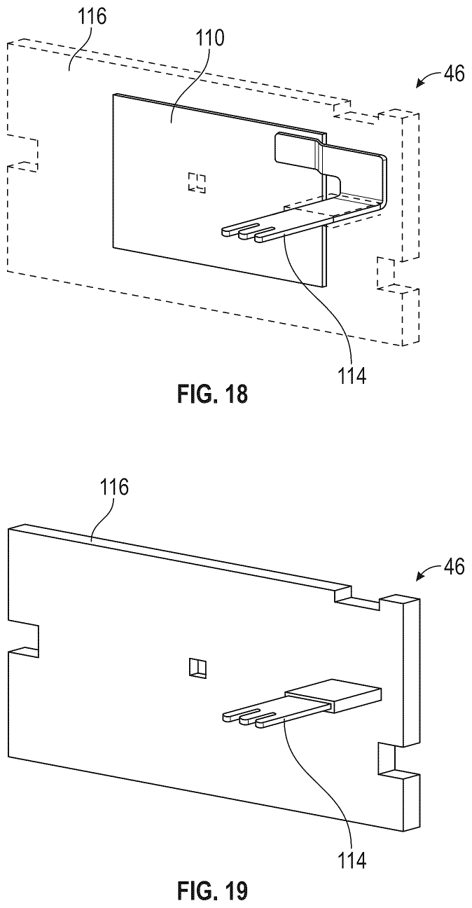

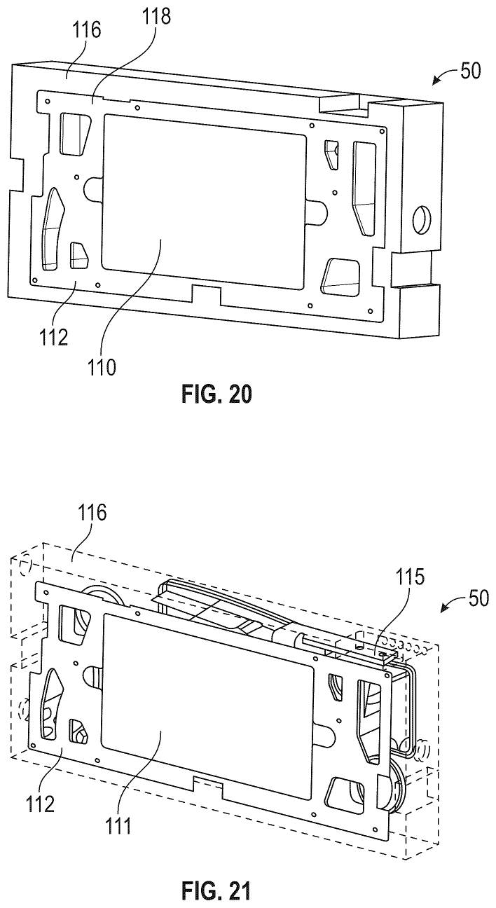

FIG. 18-19 illustrate first collector plate 110 over molded with a first polymeric material 116 to form the dry end unit 46. A collector plate terminal 114 may be connected to the first collector plate 110 and may extend from the dry end unit 46. A stainless steel plate 112, for example as shown in FIGS. 20-21, may be attached to the dry end unit 46 or may be over molded to the dry end unit 46.

FIGS. 20-21 illustrate a first collector plate 110 over molded to the wet end unit 50 and a collector plate terminal 114 extending from the wet end unit 50. As similarly described with respect to FIG. 19, a stainless steel plate 112 may be attached to the wet end unit 50 or may be over molded to the wet end unit 50.

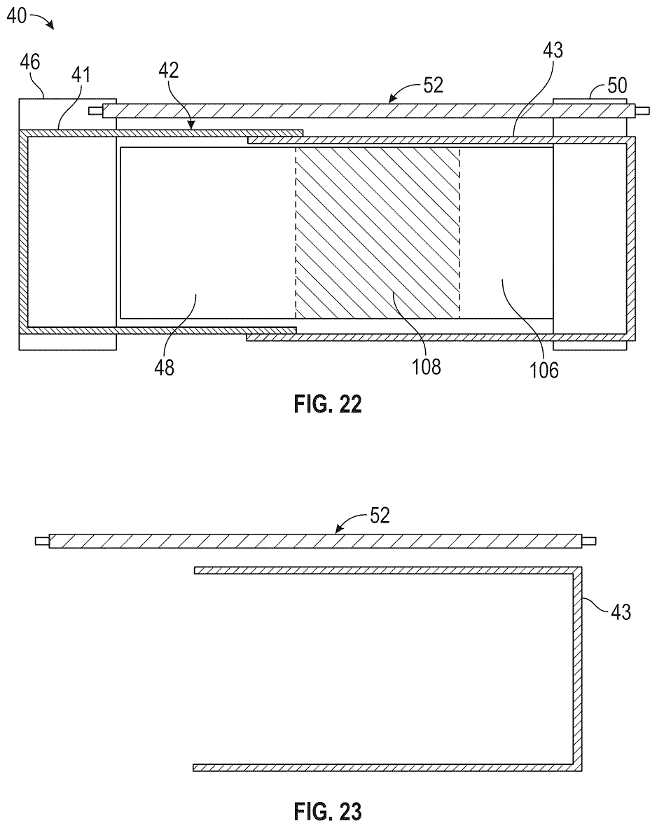

FIGS. 22-23 illustrate a fuel cell stack sub-assembly 40 which has been modified from that shown in FIG. 1, to include a fuel cell compression band 42 having a first piece 41 and a second piece 43 compressing a wet end unit 50, a fuel cell block 48, additional fuel cells 108, and additional functional component 106, a dry end unit 46. In order to add the additional fuel cells 108 and the additional functional component 106 only the over molded bus bar 52 and the second piece 43 of the fuel cell compression band 42 may be modified. The modification may include utilizing an over molded bus bar 52 that is longer and a longer a second piece 43 so that the compression band is longer.

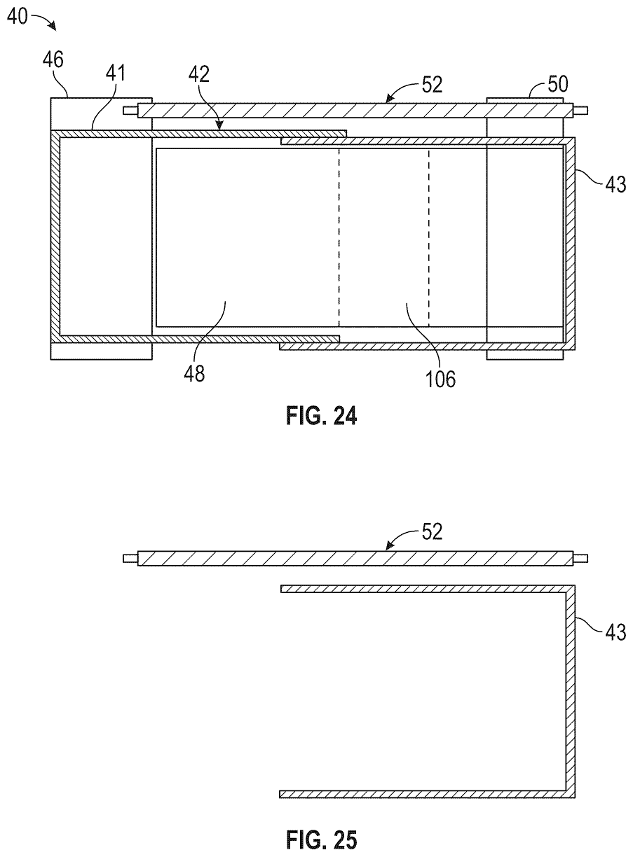

FIGS. 24-25 illustrate a fuel cell stack sub-assembly 40 which has been modified from that shown in FIG. 1, to include a fuel cell compression band 42 having a first piece 41 and a second piece 43 compressing a wet end unit 50, a fuel cell block 48 that has fewer fuel cells, an additional functional component 106, and a dry end unit 46. In order to accommodate fewer fuel cells in the fuel cell block 48 and the additional functional component 106 only the over molded bus bar 52 and the second piece 43 of the fuel cell compression band 42 may be modified. The modification may include utilizing an over molded bus bar 52 that is shorter and a second piece 43 of the compression band that is shorter than that shown in FIGS. 22-23.

The fuel cell and/or components thereof disclosed herein may be used in a vehicle or used in non-vehicle applications. For example, fuel cells may be used in a vehicle and operatively connected to an electric propulsion motor to propel the vehicle, electric brakes, electric actuators, other electric motors, or electronics in the vehicle. Electric power generated by a fuel cell may be stored in a vehicle battery or capacitor. Fuel cells can be used in a wide range of applications providing power for applications across multiple sectors, including transportation, industrial/commercial/residential buildings, and long-term energy storage for the grid in reversible systems. Fuel cells may be used to generate electricity for various applications including powering a variety of vehicles including, but not limited to, cars, truck, buses, trains, boats, airplanes, and manned or unmanned craft operable in water, on land, underground, in air, or in space. Fuel cells may also be used to provide backup power for buildings like hospitals and data centers, and for powering portable electronic devices.

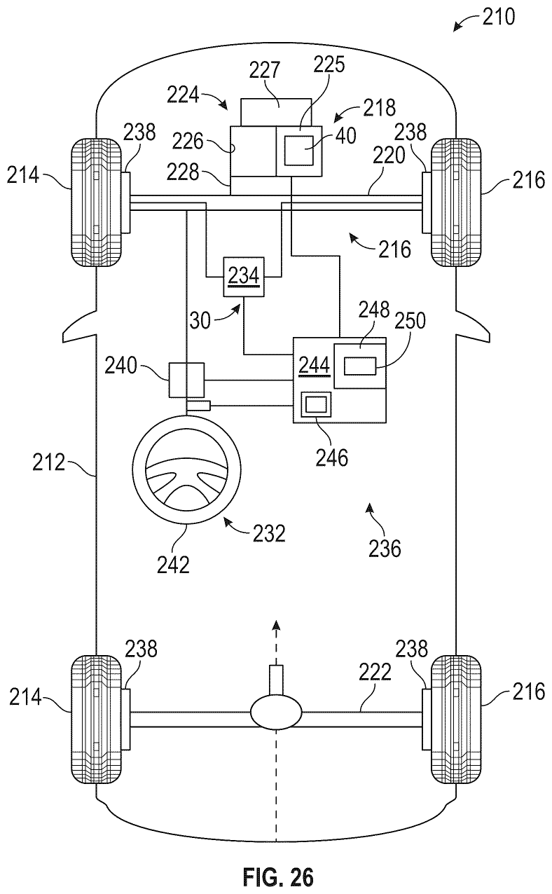

FIG. 26 illustrates a number of variations of a vehicle 210 in functional block diagram form. In a number of variations, the vehicle 210 may be an automobile. The vehicle 210 may be any one of a number of different types of vehicles, for example but not limited, a sedan, a wagon, a van, a truck, or a sport utility vehicle (SUV), and may be two-wheel drive, for example, rear wheel drive or front wheel drive, a four wheel drive or all-wheel drive, and/or various other types of vehicles in certain variations. In certain variations, the vehicle 10 may also include another type of mobile platform.

The vehicle 210 may include a body 212 that may be arranged on or integrated with a chassis. The body 212 may substantially enclose other components of the vehicle 210. The vehicle 210 may also include a plurality of wheels 214 and 216, which may be referred to as left or driver side wheels 214, and right or passenger side wheels 216. The wheels 214 and 216 may be each rotatably coupled to the chassis near the respective corners of the body 212 to facilitate movement of the vehicle 10. In a number of variations, the vehicle 210 may include four wheels 214 and 216, although this may vary in other variations, for example, for trucks and certain other vehicles.

A drive system 218 may be mounted in the vehicle 210 to drive the wheels 214 and 216, for example via axle 220, and axle 222. In certain variations, the drive system 218 may include a drive unit 224. In certain variations, the drive unit 224 may include an electric motor/generator 226, which is coupled with a transmission system 228.

The vehicle 210 may also include a braking system 230 and a steering system 232. In a number of variations, the braking system 230 controls braking of the vehicle 210 using a brake actuator 234 that may be controlled via inputs provided by the driver, such as through a brake pedal coupled to the brake actuator 234, and in a number of variations, via automatic control by a control system 236. The braking system 230 may include brakes, such as brake 238, at any of a number of the wheels 214 and 216. In a number of variations, the steering system 232 controls steering the vehicle 210 via a steering actuator 240, such as with inputs from a steering wheel 242 (for example, in connection with a steering column coupled to axle 220 and/or wheels 214 and 216), that are controlled via inputs provided by the driver, and in certain variations via automatic control via the control system 236.

In a number of variations, the control system 236 may be coupled with various systems including the braking system 320 and the steering system 232 of the vehicle 210. In a number of variations, the control system 236 may also be coupled to one or more other systems and/or components of the vehicle 210 including, for example controller 244. The controller 244 may include an electronic processor 246, non-transitory memory 248 with written instructions stored thereon executable by the electronic processor 246 to execute any of a number of acts to operate the vehicle 210 or components thereof.

The controller 244 may be coupled with various actuators including brake actuator 234, steering actuator 240, and drive unit 224. The controller 244 may also be coupled with various sensors that sense observable conditions of the vehicle 210. In a number of variations, the sensing devices may include, but not limited to, a braking sensor such as a pedal position sensor, a steering angle sensor, an acceleration sensor, and a torque request sensor, such as at the accelerator pedal or throttle.

In a number of variations, the controller 244 may be coupled to other devices, the sensors, the braking system 230, the steering system 232, the drive unit 224 and/or other systems command devices, or components of the vehicle 10, including a fuel cell stack 225 having a fuel cell stack sub-assembly 40, and a battery 227. The fuel cell stack 225 may be operatively coupled to the battery 227 to store energy generated by the fuel cell stack 225 or operatively coupled to any of the component of the vehicle 210 requiring electrical power such as the electric motor/generator 226. The battery 227 may also be operative coupled to the electric motor/generator 226 to provide power to drive the electric motor/generator 226 or store power generated by the electric motor/generator 226.

While at least one variation has been presented in the foregoing detailed description, it should be appreciated that a vast number of variations exist. It should also be appreciated that the variation or variations are only examples, and are not intended to limit the scope, applicability, or configuration of the disclosure in any way. Rather, the foregoing detailed description will provide those skilled in the art with a convenient road map for implementing the illustrative variation or variations. It should be understood that various changes can be made in the function and arrangement of elements without departing from the scope of the disclosure as set forth in the appended claims and the legal equivalents thereof.

What is claimed is:

1. A product comprising:
a fuel cell compression band comprising a first piece including a first end portion having a first plurality of parallel elongated slots formed therein.

2. The product as set forth in claim 1 wherein the first piece of the fuel cell compression band includes a second end portion having a second plurality of parallel elongated slots formed therein.

3. The product as set forth in claim 1 wherein the fuel cell compression band includes a second piece having a first end portion having a plurality of threaded weld studs positioned so that one of the plurality of threaded weld studs extends through one of the first plurality of parallel elongated slots.

4. The product as set forth in claim 2 wherein the fuel cell compression band includes a second piece having a second end portion including a plurality of threaded weld studs positioned so that one of the plurality of threaded weld studs extends through one of the first plurality of parallel elongated slots.

5. The product as set forth in claim 3 further comprising a wet end unit comprising a first polymeric material, a dry end unit comprising a second polymeric material, and a fuel cell block between the wet end unit and the dry end unit, and wherein the fuel cell compression band is compressing the wet end unit, the fuel cell block, and the dry end unit.

6. The product as set forth in claim 5 wherein the first polymeric material and the second polymeric material each comprise a fiber glass reinforced polymer.

7. The product as set forth in claim 5 further comprising at least one of an ejector, water separator, or back flow prevention device integrated into the wet end unit.

8. The product as set forth in claim 5 further comprising a collector plate over molded in at least one of the wet end unit or the dry end unit.

9. The product as set forth in claim 5 further comprising a plurality of ribs in at least one of the wet end unit or the dry end unit.

10. The product as set forth in claim 5 further comprising a plurality of ribs in the wet end unit constructed and arranged to support water separation in the wet end unit.

11. The product as set forth in claim 5 further comprising a plurality of ribs in at least one of the wet end unit or the dry end unit, wherein the plurality of ribs is constructed and arranged to transfer mechanical load or accommodate thermal expansion of the fuel cell block.

12. The product as set forth in claim 5 further comprising thermal loop integrated in at least one of the wet end unit or the dry end unit.

13. The product as set forth in claim 5 wherein the fuel cell block comprises a plurality of bipolar plates and an over molded bus bar constructed and arranged to electrically connect to the fuel cell block.

14. The product as set forth in claim 5 further comprising an over molded bus bar electrically connected to the fuel cell block.

15. A product comprising:
a fuel cell sub-assembly comprising a wet end unit comprising a first polymeric material, a dry end unit comprising a second polymeric material, and a fuel cell block between the wet end unit and the dry end unit, and at least one of an ejector, water separator, or back flow prevention device integrated into the wet end unit.

16. The product as set forth in claim 15 further comprising:
a fuel cell compression band compressing the wet end unit, the fuel cell block, and the dry end unit.

17. The product as set forth in claim 16 wherein the fuel cell compression band comprises a first piece including a first end portion having a first plurality of parallel elongated slots formed therein.

18. The product as set forth in claim 17 wherein fuel cell compression band includes a second piece having a first end portion having a plurality of threaded weld studs positioned so that one of the plurality of threaded weld studs extends through one of the first plurality of parallel elongated slots.

19. The product as set forth in claim 16 further comprising a collector plate over molded in the wet end unit or the dry end unit.

20. A vehicle comprising:
a fuel cell comprising a wet end unit comprising a first polymeric material, a dry end unit comprising a second polymeric material, and a fuel cell block between the wet end unit and the dry end unit, a fuel cell compression band being constructed and arranged to have a variable length, the fuel cell compression band comprising a first piece including a first end portion having a first plurality of parallel elongated slots formed therein, the fuel cell compression band comprising a second piece having a first end portion having a plurality of threaded weld studs positioned so that one of the plurality of threaded weld studs extends through one of the first plurality of parallel elongated slots, a plurality of threaded nuts, wherein one of the plurality of threaded nuts is threaded on one of the plurality of threaded weld studs extend extending through one of the first plurality of parallel elongated slots so that the fuel cell compression band compresses the wet end unit, the fuel cell block, and the dry end unit.
